(19) United States
(12) Patent Application Publication
(10) Pub. No.: US 2004/0048604 A1
(43) Pub. Date: Mar. 11, 2004

(54) Advertisement services on mobile terminals

(76) Inventor: Tsuneo Idei, London (GB)

Correspondence Address: FLYNN THIEL BOUTELL & TANIS, P.C., 2026 RAMBLING ROAD, KALAMAZOO, MI, 49008-1699, US

(21) Appl. No.: 10/365,569

(22) Filed: Feb. 12, 2003

(30) Foreign Application Priority Data
Sep. 5, 2002 (GB) 0220664.7

(51) Int. Cl. H04Q 7/20

(52) U.S. Cl. 455/414.1; 455/414.3; 455/414.4

(57) ABSTRACT

A method is provided for providing advertisement services on mobile telephones. A transmission is sent from a first terminal to a second terminal via a transmission network. Advertisement data is attached to the transmission by the first terminal. A second terminal receives the transmission of the advertisement data and displays the advertisement data to a user of a second terminal.

This invention relates to the provision of advertisement services on mobile terminals such as mobile telephones or other mobile communication devices.

The providers of mobile communication services have appreciated that the types of devices currently in use and those contemplated for future use give great scope for widespread distribution of advertisements to users. Users may elect to allow their terminals to receive advertisements and in turn for this may receive a discount on their telephone charges from the network operator or may receive some other benefit from an advertising agent using the network facilities.

A number of schemes have been proposed for distributing advertisements to users. For example, mobile phones are supplied with memories which can store advertisement data and can display this in response to an incoming call. Such schemes, however, do not optimize the updating or replacement of advertisements stored in users terminals.

Preferred embodiments of the present invention seek to provide a scheme in which advertisements may be propagated between users as they send data messages (e.g. MMS messages) to each other. By enabling the messages to propagate between users, initial sending of advertisements to a few selected high usage customers will enable advertisements to be sent on to all their contacts as they are phoned by that high usage customer. In many cases, a high usage customer will have contacts who have similar demographic characteristics thereby improving the targeting of advertisements to appropriate customers.

The invention is defined in more detail in the appended claims to which reference should now be made.

Preferred embodiments of the invention will now be described in detail by way of example with reference to the single figure which shows a schematic diagram of a mobile communications network in which the invention may be embodied.

Advertisements are transmitted to a mobile terminal as an attachment to an incoming message from another user. This may be a voice message, a text message or a multimedia message. The advertisement data can be distinguished from the user message by the receiving terminal by its data format.

In a first embodiment of the invention, an originating terminal 2 sends a message 4 to another terminal via the network 8. The originating terminal attaches an advertisement 6 stored in its internal memory to the message. The network 8 treats the message and attachment as a single entity. These are then processed by the network and routed to a destination terminal 10.

At the destination terminal, a user may have elected not to receive advertisements or he may be in possession of a terminal which is unable to display advertisements. The receiving terminal may then discard the attachment or, reject the entire message. If the entire message is discarded then the network is configured to detect this and to resend the original user message with no attachment. If the receipt of advertisements is permitted by the terminal then the advertisement is both stored in internal memory and displayed to the user prior to acceptance of the incoming call or message. When subsequent messages are received with attachments, the terminal will compare the content of the attachment with the data stored in its internal memory to determine whether or not there is any difference in the received advertisement data. If there is a difference, then the stored data will be updated or replaced with the new data and the updated or new advertisement displayed to a user prior to his acceptance of the incoming call or message. If the data of the attachment is the same as the stored data then all that happens is the stored data is displayed to the user.

In a second embodiment, also described with reference to the same figure, if an originating user sends a user message 12, this is passed by the network 8 to an advertisement attachment server 14 which processes this message. The advertisement attachment server can interrogate one or more other network servers 16. The advertisement server can then send a directory number of a destination terminal to one of these other network servers and may obtain the following information for use in determining which if any advertisement is to be attached to the user message:

a) whether a destination user has elected to receive advertisements;

b) whether the destination terminal can support the receipt of advertisements;

c) the location of the destination terminal; and

d) the known preferences or personal profile of a destination user.

This information is then used to determine whether or not an advertisement should be attached to the user message. The advertisement may be selected from a plurality of advertisements in the server 14.

Once an advertisement 6 has been attached, the network subsequently sends the message and the attached advertisement to the destination terminal. If the message is not passed to the advertisement attachment server then the receiving terminal may not permit or support the receipt of advertisements. If this is the case, it will discard the attachment or reject the entire message. If the entire message is rejected then the network will resend the original user message with no attachment.

In the above described second embodiment, the number of options a), b), c), d) used in determining whether or not to attach an advertisement may be a shorter or longer list. For example, only a) and b) may be used in making the determination.

In the second embodiment, the receiving terminal 10 will again compare the received advertisement data with advertisement data stored in its internal memory to determine whether or not there is any difference. If there is a difference, the data in the internal memory will be updated or replaced with the new advertisement data and the new advertisement data displayed. If the received data is the same then no updating is required and the old data is displayed to the user.

Terminals may be provided with sufficient memory capacity to store multiple advertisements simultaneously. The terminal may then display these advertisements sequentially on receipt of an incoming message.

Alternatively, they may be given priority and displayed in priority order. Typically, the highest priority advertisement will be the one attached to the current incoming message. This could then be kept as the highest priority advertisement for display until a new advertisement is received with a subsequent message.

The advertisement data sent to terminals includes a number of parameters set by the advertisement distribution and control function of the network which influences its manner of display. These parameters may determine or effect the following:

a) the relative frequency of display of that advertisement or its priority of other advertisements;

b) the maximum number of times the advertisement can be displayed, indicated by a “time-to-live” counter stored in a non-volatile memory in the terminal which is derimented each time the advertisement is displayed. When the counter reaches zero, the advertisement is deleted from the memory of the terminal;

c) the validity of an advertisement as determined by a calendar or date function within the terminal. After a preset date, the advertisement will expire and be deleted from the terminal; and

d) the timing of display of that advertisement as determined by a clock function within the terminal. The terminal may be configured such that an advertisement is displayed prompted by a message rather than a call and may be displayed immediately and then cancelled once a key on the terminal has been pressed. As there may be an interval between the receipt of a message and the user viewing it, the advertisement displayed may be subject to the following:

i) the advertisement is displayed only if within its data of format it is marked as not being sensitive; and

ii) the advertisement is displayed for a specific period after receipt by the terminal.

In a third embodiment, a message 20 may be sent from a terminal 2 with an advertisement 22 attached. This is sent to the network which interrogates the server 16 for profile data of the intended recipient 10. It determines whether or not that recipient has elected to receive advertisement data and, whether or not his profile matches that required for this particular advertisement and sends the message on as message 12 with the advertisement attachment 6 in dependence on this determination.

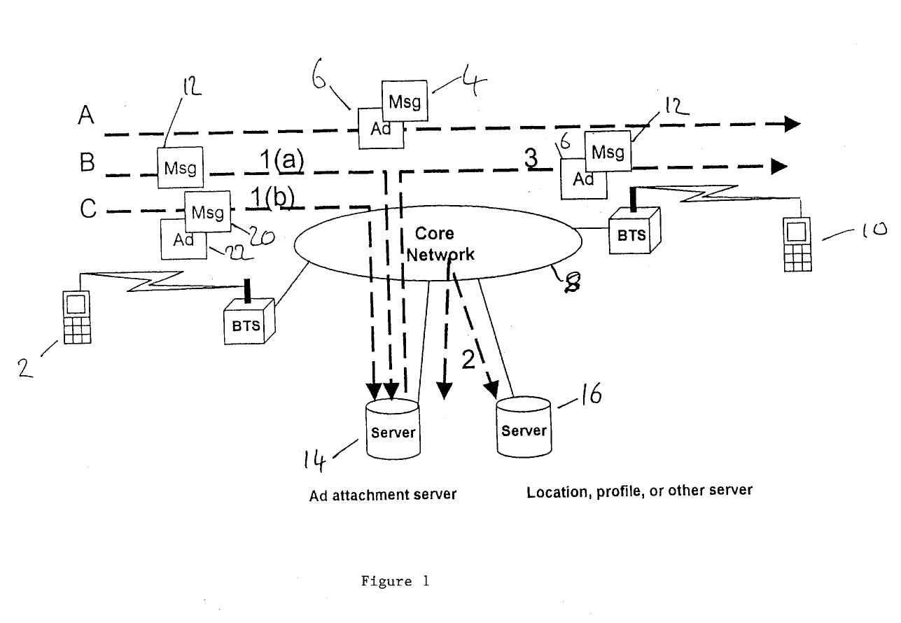

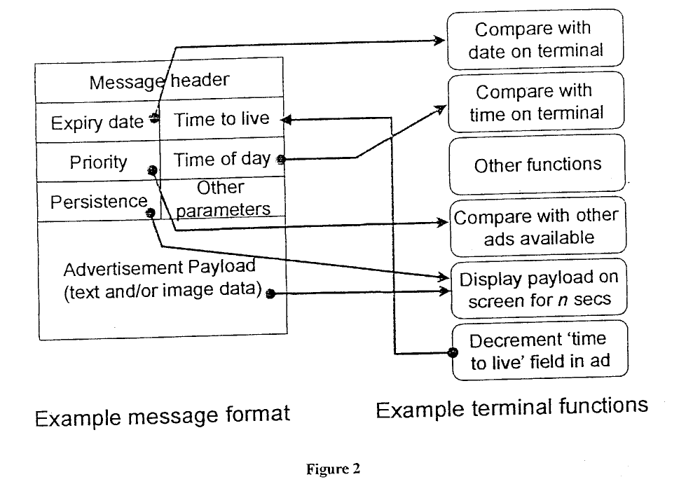

An example of a message format and its interaction with a terminal and the data shown on a terminal is illustrated in FIG. 2. As can be seen, the advertisement message includes the following:

a) a message header

b) an expiry date

c) a time-to-live

d) the priority

e) time of day

f) a persistence rate

g) any other parameters

h) the advertisement pay load advising text and/or image data.

The expiry date is compared with a date on the receiving terminal to determine whether or not that advertisement should be displayed at all.

A time-to-live is used to determine whether or not there is time left to display the advertisement.

The priority data is compared with priority data for other advertisements available on the terminal to determine in which order the advertisements should be shown.

The time of day is compared with the time on the terminal to determine whether or not it is the appropriate time of day to display the advertisement.

The persistence data is used to instruct the terminal to display the advertisement for a given number of seconds.

The time-to-live field is decremented by the terminal. The effect of this is that once the time-to-live field has been decremented to zero, the advertisement will not then be sent to any other terminals.

Using the system described above will enable advertisements to be propagated amongst users, often users who will have similar profiles and will enable widespread distribution of the advertisement. The user who has physically elected to receive advertisements may be able to obtain a discount on his mobile communication device charges as a result of this.

1. A method for providing advertisement services on mobile telephones comprising the steps of:
sending a transmission from a first terminal to a second terminal via a network;
attaching advertisement data to the transmission;
receiving the transmission and advertisement data at the second terminal; and
displaying the advertisement data to a user of the second terminal.

2. A method according to claim 1 in which the step of attaching the advertisement data to the message is performed by the first terminal and the advertisement data comprises data stored in an internal memory of the first terminal.

3. A method according to claim 1 in which the step of attaching advertisement data to the message is performed by the network as the transmission passes through the network.

4. A method according to claim 3 in which the network includes an advertisement data server for providing advertisement data to attach to a transmission.

5. A method according to any previous claim including the step of storing the advertisement data in the second terminal.

6. A method according to claim 5 including the step of comparing received advertisement data with the stored advertisement data and updating the stored advertisement data in dependence on the result of the comparison.

7. A method according to claims 5 or 6 including the step of storing data for more than one advertisement in the second terminal.

8. A method according to claim 7 including the step of assigning priorities to each of the stored advertisements and displaying them in dependence on the assigned priorities.

9. A method for providing advertisement services on mobile terminals substantially as herein described.
